(19) United States
(12) Patent Application Publication
(10) Pub. No.: US 2026/0309217 A1
(43) Pub. Date: Oct. 8, 2026

(54) ROLLER HARMONIC DRIVE TRANSMISSION HAVING A FLEX SPLINE AND A CIRCULAR SPLINE

(71) Applicant: Harmonic Drive SE, Limburg an der Lahn (DE)

(72) Inventor: Frank ZENS, Diez (DE)

(73) Assignee: Harmonic Drive SE, Limburg an der Lahn (DE)

(21) Appl. No.: 19/482,845

(22) PCT Filed: Apr. 10, 2024
(86) PCT No.: PCT/EP2024/059735

§ 371 Date: Nov. 10, 2025

(30) Foreign Application Priority Data
May 11, 2023 (DE) 102023112410.2

(51) Int. Cl. F16H 49/00; F16C 19/26

(52) U.S. Cl. CPC F16H 49/001; F16C 19/26; F16H 2049/003

(57) ABSTRACT

A roller gear or roller harmonic drive transmission (8) has a wave generator (6) having a rolling bearing (7), a flex spline (4) having outer teeth (9), and a circular spline (1). In the circular spline (1), in particular at least in parts, cylindrical pockets (2) are formed which face the outer teeth (9) of the flex spline (4) and in which roller rollers (3) are disposed. The ratio of the difference between the major axis (A) of the wave generator (6) and the inside diameter (I) of the flex spline (4) to twice the ratio of the pitch circle diameter (T) of the rollers to the number of rollers is less than 0.8.

### CROSS REFERENCE TO RELATED APPLICATIONS

This application is a national stage application (under 35 USC § 371) of PCT/EP2024/059735, filed Apr. 10, 2024, which claims benefit of DE 10 2023 112 410.2, filed May 11, 2023, the contents of each of which is incorporated by reference herein.

### BACKGROUND OF THE INVENTION

The invention relates to a roller gear or roller harmonic drive transmission.

For roller gear or roller harmonic drive, 30 is currently the smallest commercially available reduction ratio. Roller gear or roller harmonic drive with low reduction ratios (<=50) have limited performance data and are subject to greater wear.

Based on the disadvantages described above, the invention aims to provide a roller gear for small reduction ratios with improved performance data compared to state-of-the-art roller gear.

### SUMMARY OF THE INVENTION

A roller gear or roller harmonic drive is provided that has a wave generator with a roller bearing, a flex spline (FS) with external teeth, and a circular spline (CS), wherein cylindrical pockets facing the external teeth of the flex spline are formed in the circular spline, at least in part, in which rollers are arranged and/or guided, and wherein the ratio of the difference between the major axis of the wave generator and the inner diameter of the flex spline and twice the ratio of the pitch circle diameter of the rollers and the number of rollers is less than 0.8.

Expressed as a formula, this means that (A−I)/(2*(T/n))<0.8 where “A” denotes the major axis of the wave generator (WG), “I” denotes the inner diameter of the flex spline (FS), “T” denotes the pitch diameter of the rollers, and “n” denotes the number of rollers. The symbol “*” denotes multiplication, the symbol “/” denotes division.

It can therefore be expressed as a mathematical formula

$$\frac{major axis WG - inner diameter FS}{2 \cdot ( \frac{pitch diameter of the roll}{number of rolls} )} < 0.8$$

$$or$$

$$\frac{A - I}{2 \cdot ( \frac{T}{n} )} < 0.8$$

The major axis A of the wave generator is the largest distance measured diametrically on the wave generator at the outer diameter of the outer ring of the wave generator bearing. The inner diameter I is the inner diameter of the tubular section of the flex spline, measured at the point of contact with the outer ring of the wave generator bearing. The pitch diameter of the rollers refers to the diameter of the circle on which the centers of the rollers lie, relative to the end face. The ratio of the pitch diameter of the rollers to the number of rollers is equivalent to the module of a gear wheel.

Advantageous embodiments of the invention are described herein.

The invention is based on the consideration that a large number of applications require roller gears or roller harmonic drive transmissions with low reduction ratios and improved performance data.

It has now been recognized that these requirements can be met by implementing the interlocking of the CS (circular spline) using rollers, needles, or needle rollers. The use of rollers reduces the deformation of the flex spline required for the transmission to function. This reduces the functional stresses on the flex spline, enabling it to transmit higher external loads. This can be achieved by ensuring that the ratio (A−I)/(2*(T/n)) is less than 0.8. This configuration also increases the service life of the roller gear.

Roller gear drives designed in this way can achieve smaller reduction ratios (e.g., 25), which are less susceptible to wear and tear and are also suitable for continuous operation. The rollers are also referred to as pins or needles.

Advantageously, the radius of the rollers is greater than the ratio of the pitch circle diameter of the rollers to the number of rollers.

Advantageously, the height of the teeth of the flex spline is smaller than the radius of the rollers.

Advantageously, the wave generator has a roller bearing which is designed as a thin-ring bearing and/or the wave generator has an elliptical disc.

The design of the circular spline (CS) is important. The rollers are guided in a solid part in cylindrical pockets. The respective cylindrical pocket extends over more or less or exactly 180° of the circumference of the roller. In particular, the CS's interlocking mechanism is formed from rollers (pins).

It is advantageous to select a roller radius that is greater than the ratio of the roller pitch circle diameter to the number of rollers.

The design of the roller mount is guided by a support wheel over more or less than half the circumference. The roller radius is advantageously greater than the ratio of pitch circle diameter (PCD) rollers to the number of rollers. This height of the respective flex spline (FS) tooth is advantageously smaller than the radius of the roller. For this design, it is advantageous to choose a height for the teeth of the flex spline that is smaller than the radius of the rollers.

A roller gear is also described, comprising a wave generator with a roller bearing, a flex spline with internal teeth, and a circular spline, wherein pockets are formed in the circular spline, in particular at least partially, cylindrical pockets facing the internal teeth of the flex spline, in which rollers are arranged, wherein the ratio of the difference between the major axis of the wave generator and the inner diameter of the flex spline to twice the ratio of the pitch diameter of the rollers and the number of rollers is less than 0.8. In this variant, the wave generator is arranged within the flex spline in the radial direction, and the circular spline is arranged outside the flex spline.

The pockets are preferably at least partially cylindrical in shape. This means, preferably, that they have a cross-section that essentially corresponds to a circular arc segment and that this cross-section is constant over the axial length of the respective pocket so that it can accommodate a roll.

The respective pocket may also be curved, which in particular means that, viewed along the cross-section, it deviates from a circular arc segment. For example, the local radius of the cross-section contour may increase/widen or decrease/narrow in certain areas. The rollers may be cylindrical or pin-shaped in particular. The rollers can also feature profiles, such as those commonly used in roller bearings to prevent edge bearing. These can be convex or logarithmic profiles, for example.

In a preferred embodiment, the roller gear is designed in a pot construction. The flex spline is pot-shaped with a wall surrounding a base. The flex spline preferably has a flange on the inside for connection to a connecting element. The flange can be designed for welding to a connecting element.

In another preferred embodiment, the roller gear is designed in a silk hat (i.e., top hat) configuration. The flex spline preferably has a flange on the outside for connection to a connecting element.

Preferably, the respective cylindrical pocket extends over an angle between 170° and 190° of the circumference of the respective roll. This angle can also be 180°, in particular.

The advantages of the invention lie in particular in the fact that the roller gear according to the invention provides a transmission for high loads and with a long service life. The described roller gear is particularly applicable in wheel drives for AGVs, in robotics (delta robots, Scara robots), wheel drives in general, drives for measuring machines, packaging machines, and food production equipment (highly dynamic drive tasks).

The use of rollers enables a more durable surface (high hardness and smoother surface) to be achieved. They can rotate inside the pocket, which reduces wear and tear. This allows a transmission with smaller deformations in the flex spline to be implemented, thereby reducing the load on the flex spline due to the transmission principle. The effect is particularly noticeable with small gear ratios.

Further objectives, advantages, features, and applications of the present invention are derived from the subsequent description of an exemplary embodiment by way of the drawings. All described and/or depicted features per se or in any combination constitute the subject matter of the present invention, regardless of their summary in the patent claims or their back-reference.

### DESCRIPTION OF THE DRAWINGS

Partially schematically, the drawings show:

FIG. 1 a roller gear in a preferred embodiment in cross-section;

FIG. 2 a detail from FIG. 4;

FIG. 3 a tooth engagement of the roller gear according to FIG. 1;

FIG. 4 a sectional view of the roller gear according to FIG. 1;

FIG. 5 wave generator of the roller gear according to FIG. 1 with large axis marked;

FIG. 6 circular spline of the roller gear according to FIG. 1 with pitch circle diameter marked;

FIG. 7 a detailed section of a roll in a pocket of the circular spline in a preferred embodiment;

FIG. 8 a detailed section of a roll in a pocket of the circular spline in another preferred embodiment;

FIG. 9 a detailed section of a roll in a pocket of the circular spline in another preferred embodiment;

FIG. 10 a detailed section of a roll in a pocket of the circular spline in another preferred embodiment;

FIG. 11 a cross-section of a flex spline with the inner diameter marked.

FIG. 12 a roller gear in a preferred embodiment, and

FIG. 13 a roller gear in another preferred embodiment, and

FIG. 14 a roller gear in another preferred embodiment.

Identical or functionally equivalent components are assigned reference symbols in the figures of the drawing shown below, based on one embodiment, in order to improve readability.

### DETAILED DESCRIPTION

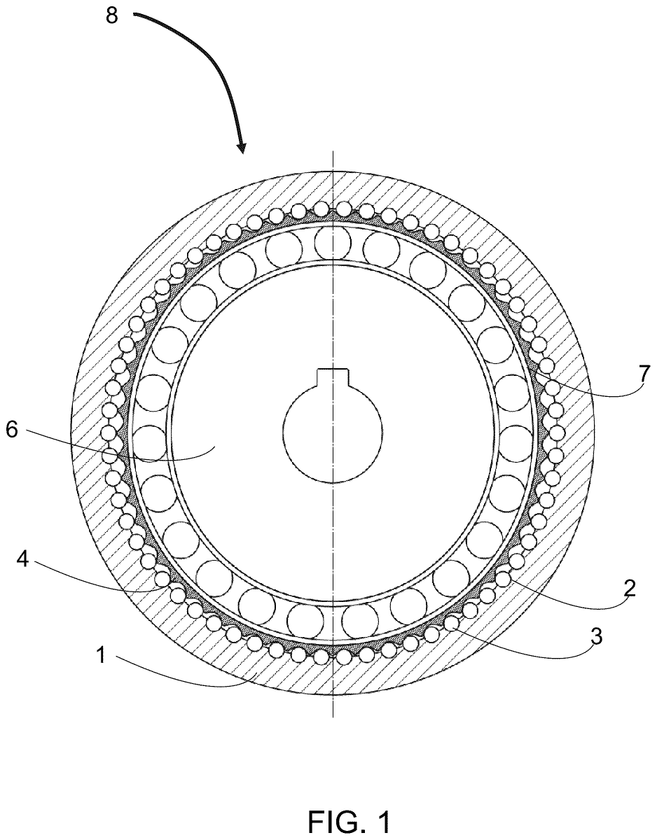

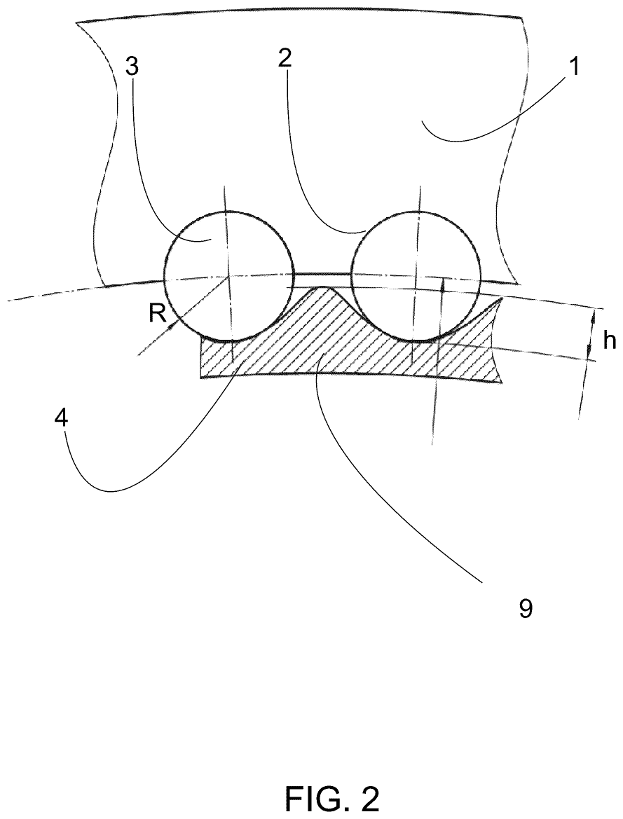

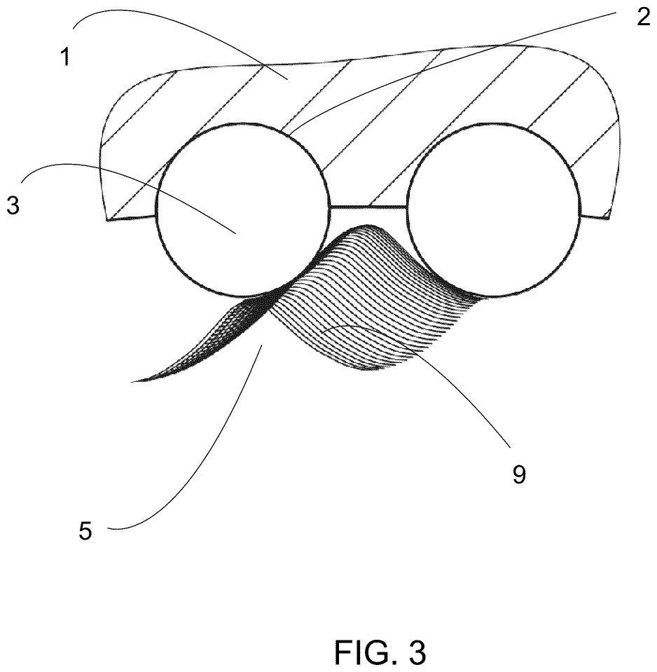

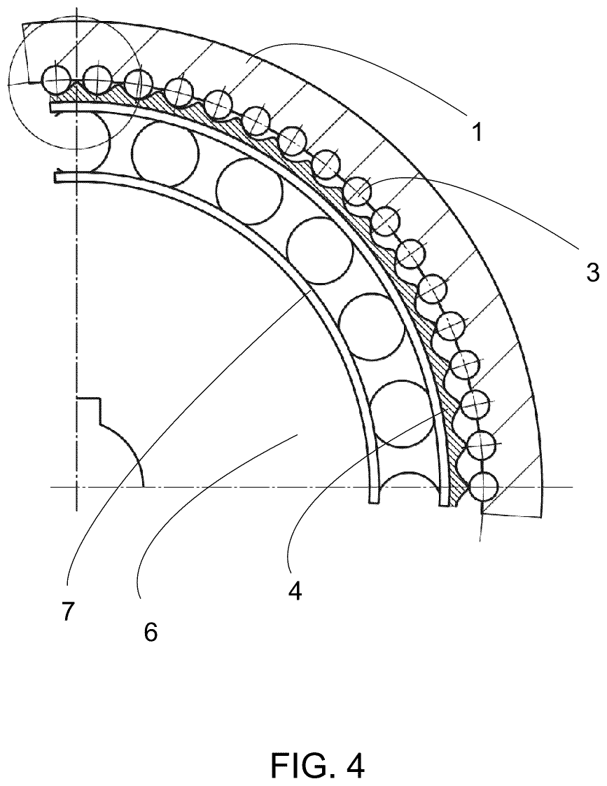

A roller gear 8 shown in FIGS. 1-4 has a wave generator 6 with a roller bearing 7 designed as a thin-ring bearing and an elliptical disc on which a flex spline 4 with external teeth 9 is arranged. The roller gear 8 also features a circular spline 1. Rollers 3, which serve as internal teeth, are guided in cylindrical pockets 2 in a solid part or circular spline 1. The pockets 2 are in particular at least partially designed as cylinders. The respective cylindrical pocket 2 extends over more or less or exactly 180° of the circumference of the roll 3, preferably between 170° and 190°.

The roller gear 8 is designed to reduce the functional internal loads on the flex spline 4 and wear in the tooth contact, thereby enabling the transmission of higher external loads and a longer service life. For this purpose, the ratio of the difference between the major axis of the wave generator 6 and the inner diameter of the flex spline 4 and twice the ratio of the pitch circle diameter of the rollers and the number of rollers is less than 0.8.

In the advantageous embodiment shown, the radius R of the rollers 3 is greater than the ratio of the pitch circle diameter T of the rollers 3 to the number of rollers n.

In the advantageous embodiment shown, the height h of the teeth of the flex spline 4 should be selected to be smaller than the radius R of the rollers 3.

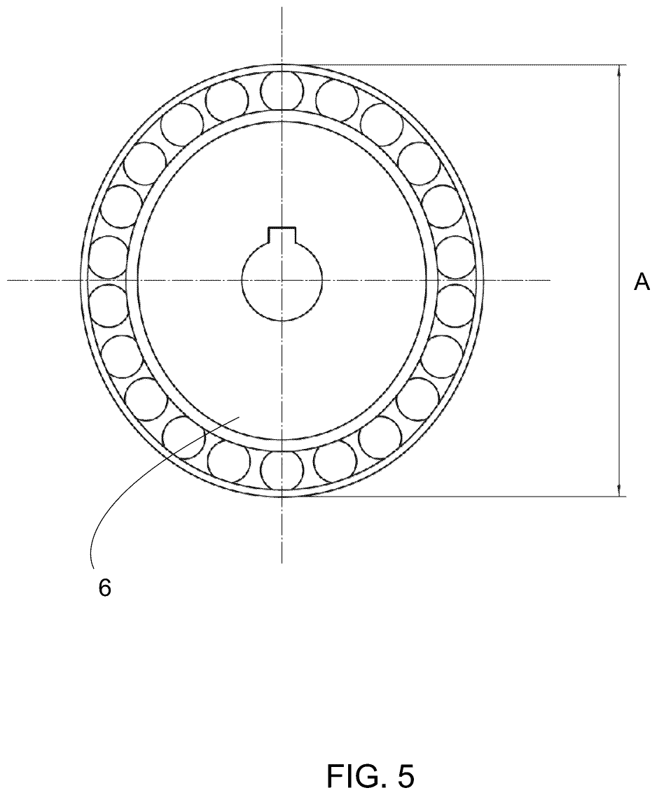

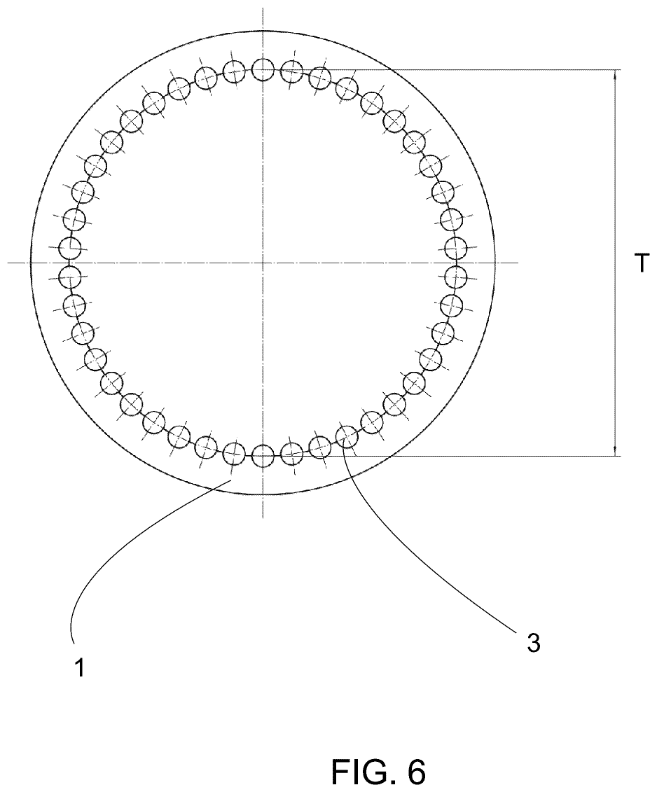

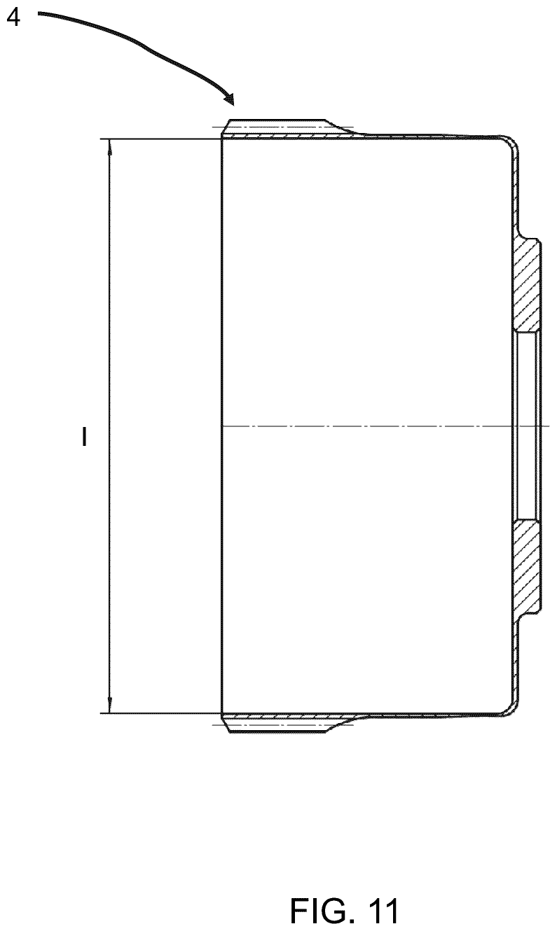

FIG. 5 shows the wave generator 7 of the roller gear according to FIG. 1 with the designated major axis A. FIG. 6 shows the circular spline with rollers 3 and pitch circle diameter T. FIG. 11 shows flex spline 4 with the designated inner diameter I.

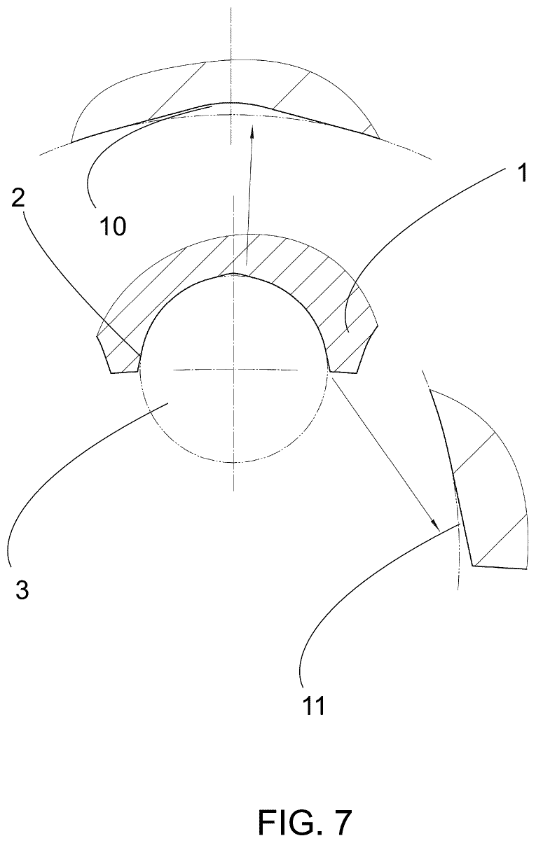

FIG. 7 shows a section of circular spline 1 with a pocket 2 and a roller 3 arranged therein in a preferred embodiment. Viewed in the radial direction, pocket 2 has an indentation 10. Viewed from the side, the pocket has a flared area; the local radius of the pocket cross-section is tangentially enlarged by a straight section. Pocket 2 encompasses roller 3 at an angle<180°. The indentation can also hold additional lubricant. Avoiding undercuts at the pocket outlet makes the pocket easier to manufacture.

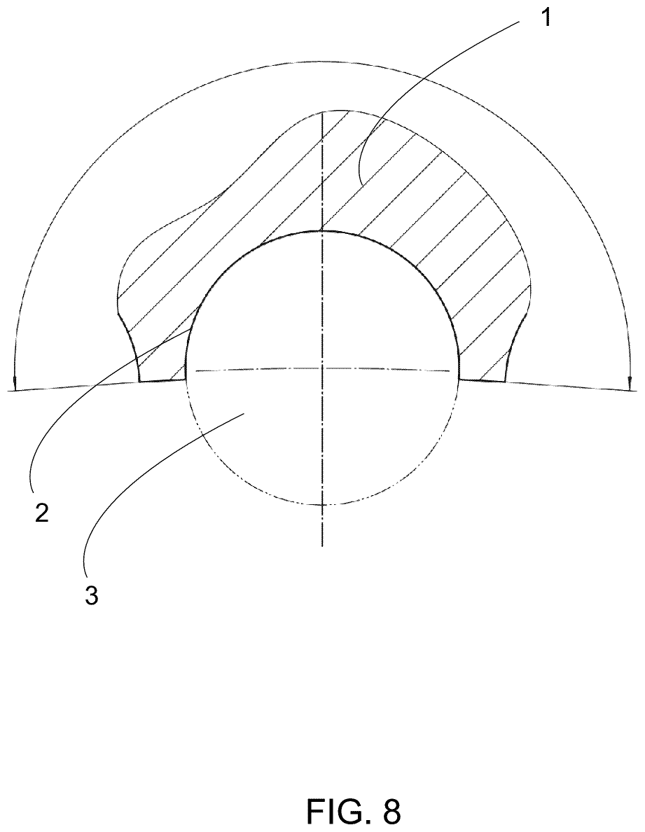

FIG. 8 shows a section of circular spline 1 with a pocket 2 and a roller 3 arranged therein in a preferred embodiment. In this embodiment, the pocket 2 encompasses the roller 3 at an angle greater than 180°, in particular 190°.

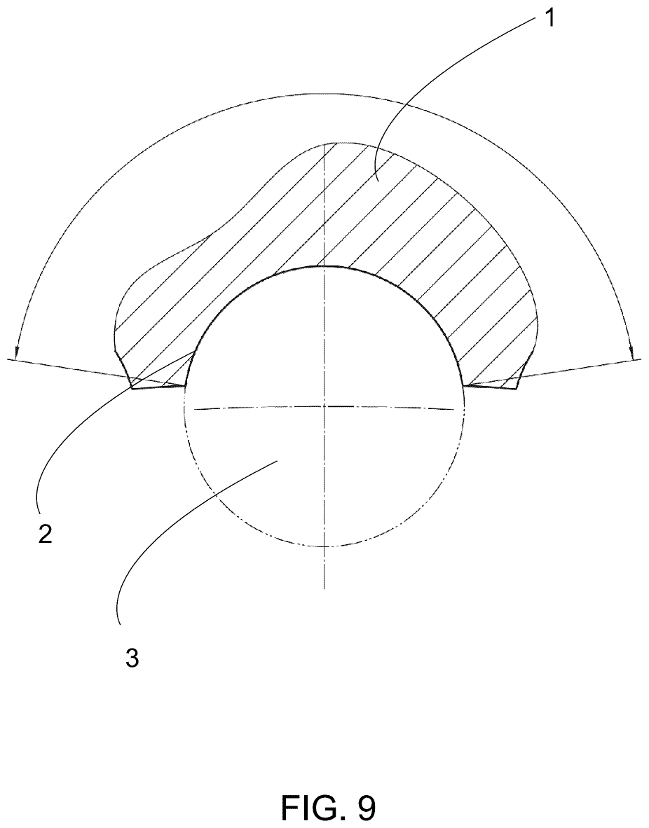

FIG. 9 shows a section of circular spline 1 with a pocket 2 and a roller 3 arranged therein in a preferred embodiment. In this embodiment, the pocket 2 encompasses the roller 3 at an angle that is less than 180°, in particular 170°.

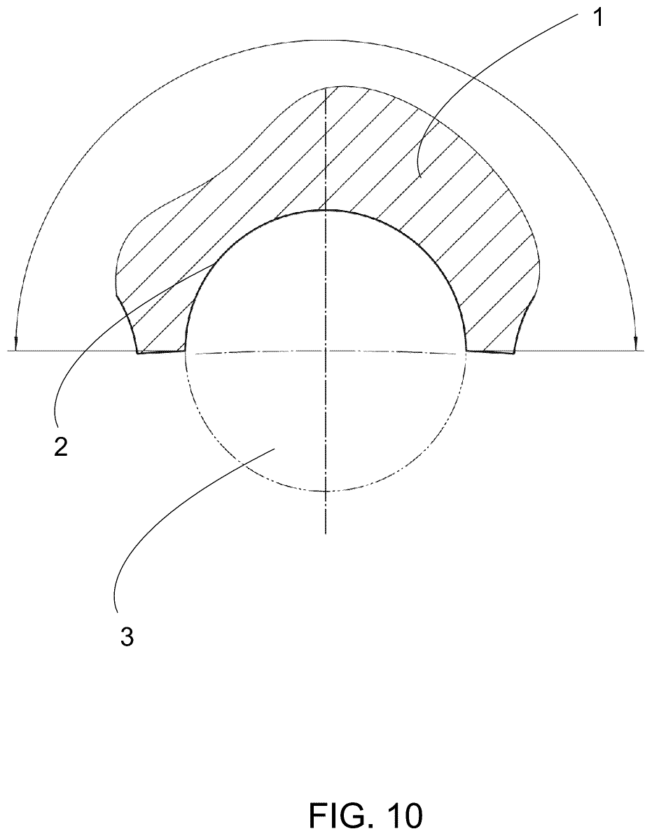

FIG. 10 shows a section of circular spline 1 with a pocket 2 and a roller 3 arranged therein in a preferred embodiment. In this embodiment, the pocket 2 encompasses the roller 3 at an angle of approximately 180°.

FIG. 11 shows a cross-section of a flex spline 4 with the inner diameter I marked.

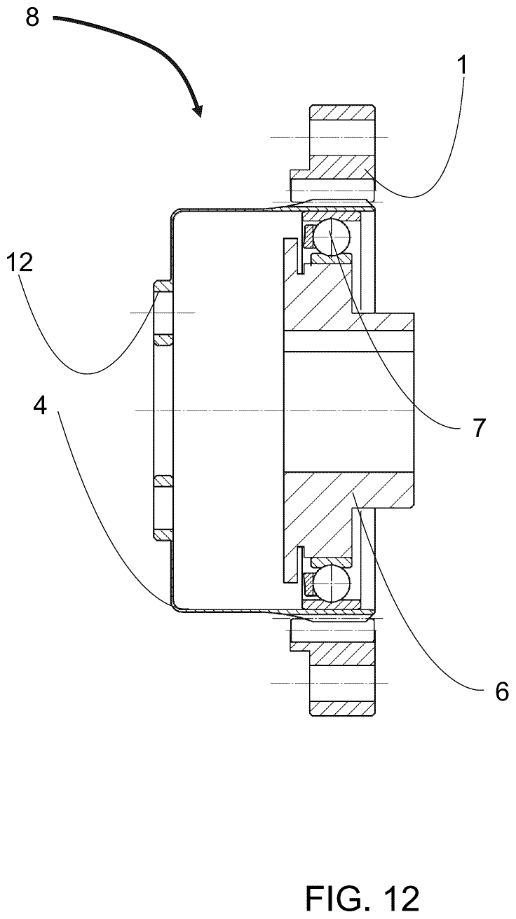

FIG. 12 shows a roller gear 8 in pot design, i.e., pot-shaped with a wall surrounding a base. In this preferred variant, the flex spline 4 has an internal flange 12 for connection to a connecting element, such as a bearing ring.

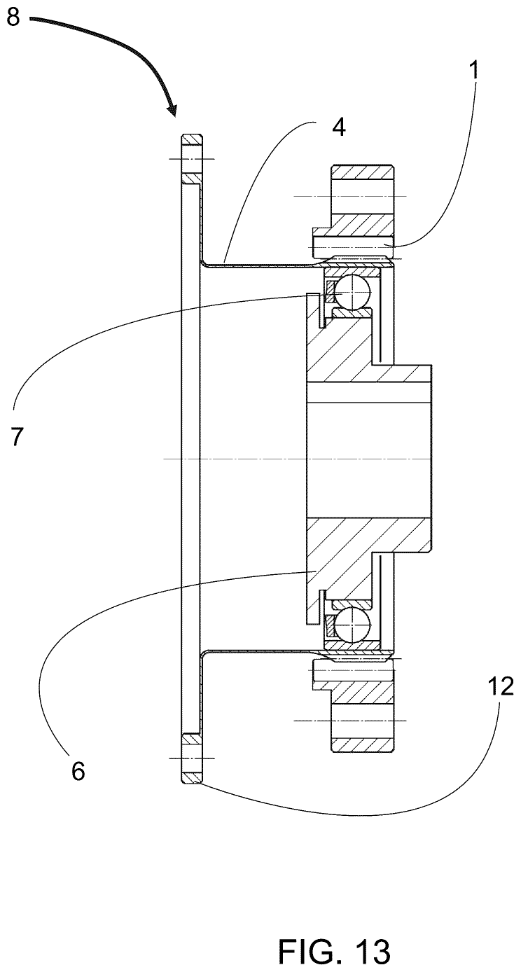

FIG. 13 shows a silk hat (i.e., top hat-shaped) roller gear 8. In this variant, the flex spline 4 has an external flange for connection to a connecting element, such as a bearing ring.

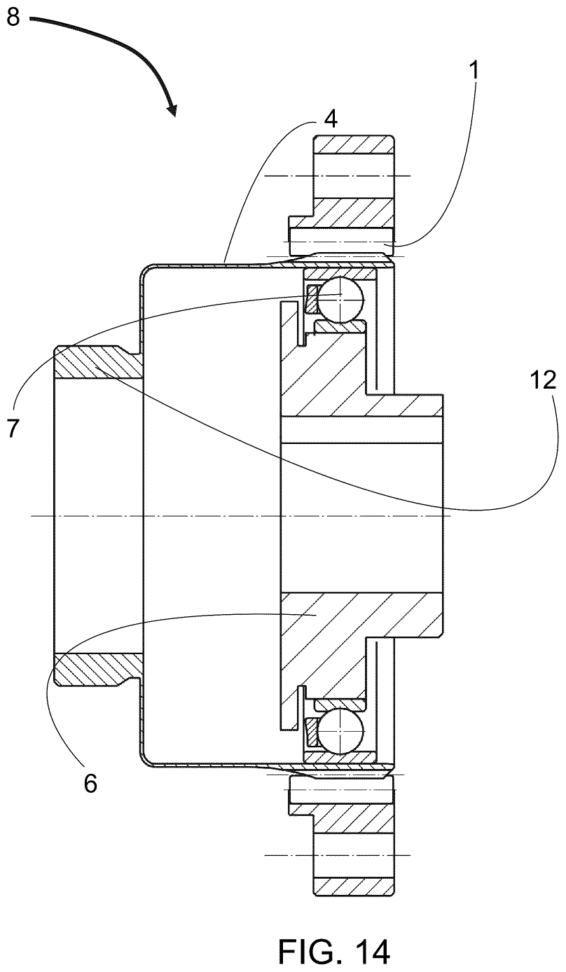

FIG. 14 shows a roller gear 8 in pot design, i.e., pot-shaped with a wall surrounding a base. In this preferred variant, the flex spline 4 has an internal flange 12 for connection to a connecting element, such as a bearing ring. The flange is designed so that the connection can be made by welding.

### REFERENCE NUMERALS

1 Circular spline
2 Pocket
3 Roll
4 Flex spline
5 Flex spline tooth
6 Wave generator
7 Roller bearing
8 Roller gear
9 External gearing
10 Indentation
11 Section
12 Flange
A Large axis of the wave generator
I Inner diameter of the flex spline
T Pitch diameter of the rollers

1. A roller gear (8), comprising:
a wave generator (6) with a roller bearing (7), said wave generator (6) defining a major axis (A),
a flex spline (4) with external teeth (5), said flex spline (4) having an inner diameter (I), and
a circular spline (1), said circular spline (1) having
pockets (2) formed therein that face the external teeth (5) of the flex spline (4), in which pockets (2) a number of rollers (3) are arranged, said rollers (3) defining a pitch circle diameter (T), wherein the ratio of the difference between the major axis (A) of the wave generator (6) and the inner diameter (I) of the flex spline (4) and twice the ratio of the pitch circle diameter (T) of the rollers and the number of rollers is less than 0.8.

2. The roller gear (8) according to claim 1, wherein each of the rollers (3) has a radius (R) and the radius (R) of the rollers (3) is greater than the ratio of the pitch circle diameter (T) of the rollers (3) to the number of rollers (3).

3. The roller gear (8) according to claim 1, wherein each of the rollers (3) has a radius (R) and each of the external teeth (5) has a height (h), and the height (h) of the external teeth (5) of the flex spline (4) is smaller than the radius (R) of the rollers (3).

4. The roller gear (8) according to claim 1, wherein the roller bearing (7) of the wave generator (6) is designed as a thin-ring bearing and/or has an elliptical disc.

5. The roller gear (8) according to claim 1, wherein the flex spline (4) is pot-shaped with a wall surrounding a base.

6. The roller gear (8) according to claim 5, wherein the flex spline (4) has a flange (12) on an inside surface for connection to a connecting element.

7. The roller gear (8) according to claim 6, wherein the flange (12) is designed for welding connection to the connecting element.

8. The roller gear (8) according to wherein the flex-spline (4) is top hat shaped.

9. The roller gear (8) according to claim 8, wherein the flex spline (4) has a flange (12) on an outside surface for connection to a connecting element.

10. The roller gear (8) according to claims, wherein each roller (3) has a circumference, and wherein the respective cylindrical pocket (2) accommodating a respective one of the rollers (3) extends over an angle between 170° and 190° of the circumference of the respective roller (3).

11. The roller gear (8) according to claim 6, wherein the connecting element is a bearing ring.

12. The roller gear (8) according to claim 9, wherein the connecting element is a bearing ring.

13. The roller gear (8) according to claim 1, wherein the pockets (2) are cylindrical pockets or partially cylindrical pockets, and the pockets are formed at least in parts of the circular spline.

14. A roller harmonic drive transmission, comprising:
a roller gear comprising:
a wave generator with a roller bearing, said wave generator defining a major axis (A),
a flex spline with external teeth, said flex spline having an inner diameter (I), and
a circular spline, said circular spline having pockets formed therein that face the external teeth of the flex spline, in which pockets a number of rollers are arranged, said rollers defining a pitch circle diameter (T),
wherein the ratio of the difference between the major axis (A) of the wave generator and the inner diameter (I) of the flex spline and twice the ratio of the pitch circle diameter (T) of the rollers and the number of rollers is less than 0.8.

15. The roller harmonic drive transmission of claim 14, wherein the pockets are cylindrical pockets or partially cylindrical pockets.

16. The roller harmonic drive transmission of claim 14, wherein each of the rollers has a radius (R) and the radius (R) of the rollers is greater than the ratio of the pitch circle diameter (T) of the rollers to the number of rollers.

17. The roller harmonic drive transmission of claim 14, wherein each of the rollers has a radius (R) and each of the external teeth has a height (h), and the height (h) of the external teeth of the flex spline is smaller than the radius (R) of the rollers.

18. The roller harmonic drive transmission of claim 14, wherein each roller has a circumference, and wherein the respective cylindrical pocket accommodating a respective one of the rollers extends over an angle between 170° and 190° of the circumference of the respective roller.

19. The roller harmonic drive transmission of claim 14, wherein the roller bearing of the wave generator is designed as a thin-ring bearing and/or has an elliptical disc.

20. The roller harmonic drive transmission of claim 14, wherein the pockets are cylindrical pockets or partially cylindrical pockets, and the pockets are formed at least in parts of the circular spline.
